(19) United States
(12) Patent Application Publication
(10) Pub. No.: US 2026/0220960 A1
(43) Pub. Date: Jul. 30, 2026

(54) METHOD FOR IMPROVING THE CLASSIFICATION OF A DIGITAL DOCUMENT USING A PLURALITY OF LEARNING MODELS

(71) Applicant: XPLAIN, PARIS (FR)

(72) Inventors: Pierre MAGRANGEAS, VERSAILLES (FR); Fabio COPPINI, PARIS (FR); Renard FERRET, GAGNY (FR); Coralie BOCHART, PANTIN (FR); Yasmine SAADI, PARIS (FR); Sixtine PASSOT, PERTUIS (FR)

(21) Appl. No.: 19/141,952

(22) PCT Filed: Dec. 21, 2023
(86) PCT No.: PCT/EP2023/087483

§ 371 Date: Jun. 20, 2025

(30) Foreign Application Priority Data
Dec. 21, 2022 (FR) FR2214126

(51) Int. Cl. G06V 30/413; G06F 16/901

(52) U.S. Cl. CPC G06V 30/413; G06F 16/9024

(57) ABSTRACT

A method for improving the classification of a document from a plurality of machine learning models, includes receiving a digital document; executing a first learning function generated from a first machine learning model trained from a first training domain processing the first input data sequence and making it possible to classify a document type and generate a prediction of a first automatic action to be performed on the digital document, acquiring a first corrective action from a user relating to the modification of the movement of the first digital document to a second directory; generating a first annotation; modifying the first training domain by adding the first annotation; generating a retraining of the first machine learning model.

### FIELD OF INVENTION

The field of the invention relates to the field of methods and systems for improving the classification of a digital document, in particular for its storage in a given memory space and for its use in a memory resource.

### STATE OF THE ART

There are solutions for analyzing digital documents using machine learning models. State-of-the-art solutions generally extract either data of interest relating to the type of document in question, in order to classify it, or data of interest for exploiting the document in a certain way, by performing operations such as anonymizations, checks on named entities, etc.

Prior art solutions rely on learning to enhance a model in order to improve the classification efficiency of a learning function. One problem with prior art solutions is to involve the users of a classification solution by requiring actions on their part dedicated to improving the learning of the learning function. These actions may include label corrections, modifications to extracted data, annotations, etc.

However, these dedicated actions are not always carried out correctly, due to the heterogeneity of human behaviors to contribute to the retraining of a machine learning model, and the fact that corrective actions are not always carried out.

There is a need to define a solution for relearning a machine learning model that is simple and virtually transparent to the users exploiting the classification results.

### SUMMARY OF THE INVENTION

According to a first aspect, the invention relates to a method for improving the classification of at least one document by means of at least one machine learning model characterized in that it comprises:
Receiving a first digital document;
Executing a first learning function generated by means of a first machine learning model trained from a first training domain to generate a prediction of a classification of the first digital document within a first class to perform a first automatic action on the digital document,
Generating a representation of this classification and/or of the action performed on the first digital document from a user interface;
Acquiring a user's first corrective action;
Generating a first annotation comprising, on the one hand, the modified value of the prediction relative to the first corrective action and, on the other hand, a set of values of interest extracted or generated in particular from the first digital document;
Modifying the first training area by adding the first annotation;
Generating a retraining of the first machine learning model.

According to an embodiment, the actions may correspond, for example, to:
moving a digital document from one directory to another;
copying a document in a folder/directory;
renaming a digital document,
creating a new document and/or data space directory.

The invention is computer-implemented.

According to one aspect, the invention relates to a method for improving the classification of at least one document or of a data item of a document and/or the prediction of a data item qualifying at least one document or of a data item of a document by means of at least one machine learning model characterized in that it comprises:
Receiving a first digital document;
Executing a first trained function from a first training domain to generate a prediction of a first automatic action to be performed on the digital document,
Generating a representation of this prediction and/or of the action performed on the first digital document by means of a user interface;
Acquiring a user's first corrective action;
Generating a first annotation comprising, on the one hand, the modified value of the prediction relative to the first corrective action and, on the other hand, a set of values of interest extracted or generated in particular from the first digital document;
Modifying the first training domain by adding the first annotation after collecting at least one annotation;
Generating a retraining of the first machine learning model.

According to one embodiment, the learning function is a function generated by means of a first machine learning model trained from a first training domain. In another case, the learning function is a predefined function for extracting data from a dataset to generate a prediction, said dataset being able to evolve over time by adding, selecting or enriching data.

According to a second aspect, the invention relates to a method for improving the classification of at least one document by means of at least one machine learning model characterized in that it comprises:
Receiving a first digital document;
Executing a first learning function generated from a first machine learning model trained from a first training domain to generate a prediction of a classification of the first digital document within a first class to perform a first automatic action on the digital document, said first action comprising at least one move of said first digital document to a first directory,
Generating a representation of this classification and of the action performed on the first digital document from a user interface;
Acquiring a first corrective action from a user relating to the modification of the movement of the first digital document to a second directory;
Generating a first annotation comprising, on the one hand, the modified value of the prediction relative to the first corrective action and, on the other hand, a set of values of interest extracted or generated in particular from the first digital document;
Modifying the first training area by adding the first annotation;
Generating a retraining of the first machine learning model.

Advantageously, the directory to which the first document is moved depends on the classification. So, depending on the classification predicted by the first trained machine learning model, a given directory is targeted for moving said first document. The association between a class and a directory can be preconfigured. Generally speaking, all classes can be associated with one or more directories.

According to an aspect, the invention relates to a method for improving the classification and/or prediction of at least one document or document data by means of at least one machine learning model characterized in that it comprises:
Receiving a first digital document;
Executing a first trained function from a first training domain to generate a prediction of a first automatic action to be performed on the digital document,
Generating a representation of this prediction and/or of the action performed on the first digital document from a user interface;
Acquiring a user's first corrective action
Generating a first annotation comprising, on the one hand, the modified value of the prediction relative to the first corrective action and, on the other hand, a set of values of interest extracted or generated in particular from the first digital document;
Modifying the first training domain by adding the first annotation after collecting at least one annotation;
Generating a retraining of the first machine learning model.

According to an embodiment, the learning function is a function generated by means of a first machine learning model trained from a first training domain. In another case, the learning function is a predefined function for extracting data from a data set to generate a prediction, said data set being able to evolve over time by adding or selecting data or enriching data.

According to an aspect, the invention relates to a method for improving the classification and/or prediction of at least one document or document data by means of at least one machine learning model characterized in that it comprises:
Receiving a first digital document;
Executing a first learning function generated from a first machine learning model trained from a first training domain to generate a prediction of a first automatic action to be performed on the digital document,
Generating a representation of this prediction and/or of the action performed on the first digital document from a user interface;
Acquiring a user's first corrective action;
Generating a first annotation comprising, on the one hand, the modified value of the prediction relative to the first corrective action and, on the other hand, a set of values of interest extracted or generated in particular from the first digital document;
Modifying of the first training domain by adding the first annotation after collecting at least one annotation;
Generating a retraining of the first machine learning model.

According to an embodiment, the first corrective action relating to the modification of the displacement of the first digital document is carried out by moving the first digital document from the first directory to a second directory by a user action from a document explorer, an algorithm for detecting a change in the memory resource allocated to a digital document being implemented.

According to an embodiment, the first corrective action relating to the modification of the displacement of the first digital document is carried out by modifying the class of the first digital document by a user action from a user interface presenting a set of characteristic data of the first digital document.

According to one embodiment, the method comprises:
Receiving a second digital document;
Executing a second learning function generated from a second machine learning model trained from a second training domain to generate a prediction of a classification of the second digital document within a second class to perform a second automatic action on the second digital document, said second action including at least an automatic renaming of said second digital document,
Generating a representation of this classification and of the action performed on the first digital document from a user interface;
Acquiring a second corrective action from a user relating to the modification of the name of the second digital document;
Generating a second annotation comprising, on the one hand, the modified value of the prediction relating to the second corrective action and, on the other hand, a set of values of a second sequence of data extracted or generated in particular from the second digital document;
Modifying the second training area by adding the second annotation;
Generating a retraining of the second machine learning model.

According to an embodiment, the second corrective action relating to the modification of the name of the second digital document is carried out by modifying the name of the second digital document directly on the file corresponding to the second digital document.

According to an embodiment, the second corrective action relating to the modification of the name of the second digital document is carried out by modifying the class of the second digital document by a user action from a user interface presenting a set of data characteristic of the second digital document.

According to an embodiment, the method comprises:
Receiving a digital document;
Executing a third learning function generated from a third machine learning model trained from a third training domain to generate a prediction relating to the detection of a class of a characteristic date present in the digital document and extract said characteristic date from the first document;
Generating a classification representation of at least the characteristic date extracted from a user interface;
Acquiring of a third corrective action from a user relating to the modification of the class of the characteristic date of the first digital document;
Generating a third annotation comprising, on the one hand, the modified value of the prediction relative to the first corrective modification and, on the other hand, a set of values of interest extracted or generated in particular from the digital document;
Modifying the third training area by adding the third annotation;
Generating a re-training of the third machine learning model.

According to an embodiment, the third learning function is executed prior to the first learning function, the corrected prediction being a datum of the set of values of interest of an annotation, said corrected prediction modification resulting in the modification of the first training domain and/or the modification of the second training domain.

According to an embodiment, the method comprises receiving a dependency graph, said dependencies being defined between at least the first learning function and a second learning function, said dependency graph comprising a description of the inputs of at least one training domain, said inputs comprising at least one value corresponding to an output of at least one learning function.

According to an embodiment, the method comprises:
Acquiring a dependency graph between a plurality of learning functions selected from a set of learning functions comprising the first learning function, the second learning function and the third learning function;
Adding in at least one set of values of interest produced during the creation of an annotation of a modified prediction of a given learning function so as to:
Modifying a training domain of a learning function other than the given learning function;
Machine learning model retraining.

According to an embodiment, following an automatic action performed by a learning function, a first notification is sent via a data network, said first notification including access to a user interface enabling the annotations associated with this action to be modified.

According to an embodiment, the first machine learning model is generated from the definition of a first digital document model including the identification of a plurality of characteristic data and areas of interest of said first document model and from a user interface.

In an embodiment, following a user-generated corrective action, the first digital document model is used to extract context data from the modified prediction to enrich the annotation that is created.

In an embodiment, defining a first digital document template comprises generating a form comprising a set of choices defining annotations of said template, said annotations enabling the first training template to be updated.

According to an embodiment, a plurality of first documents are received from a same class, and a plurality of machine learning models are applied, the method comprising the generation of a plurality of predictions, the method comprising the selection of a prediction, said selection of said prediction allowing to update the first training domain.

According to another aspect, the invention relates to a system comprising a user's electronic terminal comprising at least one computer, a memory, a display and a communication interface for transmitting messages over a data network to at least one first server comprising hardware resources for executing the first learning function, the second learning function, the third learning function and a memory for storing the learned models in order to execute the steps of the method of the invention, the second learning function, the third learning function and a memory for storing the learned models in order to execute the steps of the method of the invention, the terminal comprising a user interface for acquiring an annotation comprising a modification of a prediction, said modification resulting in the retraining of at least one machine learning model.

According to another aspect of the invention relates to a method for improving the classification of a digital document from a plurality of machine learning models characterized in that it comprises:
Receiving a digital document;
Executing a first learning function generated by means of a first machine learning model trained from a first training domain, which classifies a first type of document and generates a first prediction of a first automatic action to be performed on the digital document,
Executing a second learning function generated by means of a second machine learning model trained from a second training domain to generate a second prediction for extracting and classifying a characteristic datum from the first document;
Generating a representation from a user interface of the first prediction associated with the classification and the action performed, of the second prediction comprising the date extracted from the first digital document and of the class of the date extracted from the first digital document;
Acquiring a first corrective action from a user relating to the modification of at least one prediction;
Generating a first annotation comprising, on the one hand, the modified value of the at least one prediction relating to the first corrective action and, on the other hand, a set of values of interest extracted or generated from the first digital document;
Acquiring a dependency graph between at least the first learning function and the second learning function;
Modifying the first training domain and/or the second training domain according to the annotation and the dependency graph by adding the first annotation;
Generating a retraining of the first machine learning model and/or the second learning model.

In an embodiment, machine learning models are retrained according to the dependency graph representing the links between learning functions.

In an embodiment, the method comprises applying the first machine learning model and/or the second machine learning model to the first digital document or to another document received subsequently to the first digital document.

According to an embodiment, values of interest comprise a position of a datum in the document or in a page of the document. According to another example, a value of interest comprises a sequence of discrete symbols in natural language that precedes and/or follows the corrected prediction in the document. According to an example, a value of interest is an intermediate prediction of a learning function that is in the same sequence as a learning function executed to produce the digital document that has been the object of corrective action.

### BRIEF DESCRIPTION OF FIGURES

Further features and advantages of the invention will become apparent from the following detailed description, with reference to the appended figures, which illustrate:

FIG. 1: A learning function architecture illustrating the retraining of a machine learning model of a function based on a correction made to the result produced by another learning function according to the method of the invention;

FIG. 2: Areas of interest on a page of a digital document from which a set of data is extracted by one or more learning functions according to the method of the invention;

FIG. 3: A system of the invention comprising different resources for implementing the method of the invention,

FIG. 4: An example of the generation of a new document model following an annotation produced by the method of the invention.

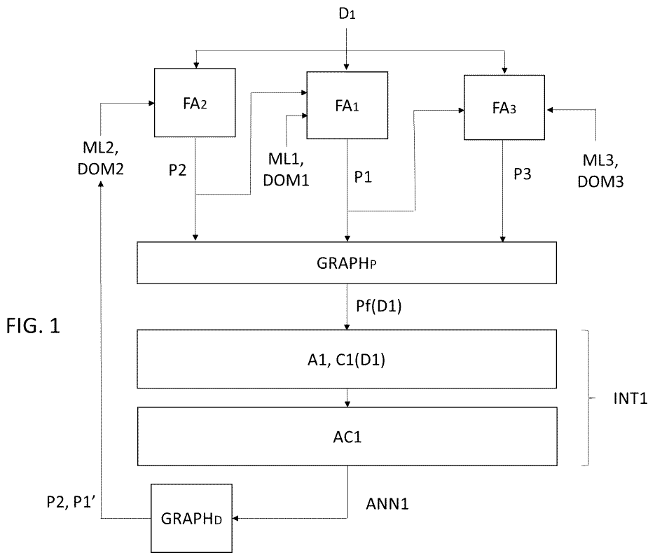

FIG. 1 shows a software architecture implementing various learning functions FA₁, FA₂ and FA₃ performing automatic operations on a digital document D₁. Each of the learning functions FA₁, FA₂, FA₃ calculates from the input document D₁ to be processed an intermediate prediction respectively noted P₁, P₂ and P₃. According to an embodiment, a prediction graph GRAPH_{P} can be used to calculate a final prediction Pf from a computer to automatically perform an action A₁ on the digital document. The A₁ action may be to move the document, rename it or use part of the D₁ document data to generate another document.

FIG. 1 also shows operation C₁ D₁, which consists in generating a representation of this action on a display. The representation can be generated in real time on a user interface, or it can be displayed after the prediction, classification or action has been performed. This representation can be generated from a user interface. A file explorer can be used to represent the movement of a folder.

FIG. 1 shows an operation corresponding to a corrective action AC₁ by a user. The corrective action may correspond to the user moving a document that has been judged to be incorrectly classified. Other corrective actions are also possible, such as renaming or correcting a value in the document or in a generated document.

The corrective action results in the automatic creation of an ANN₁ annotation. This annotation ANN₁ includes a corrected value of the final prediction Pf resulting from the corrective action. For example, the corrected prediction may be a directory name of a file system. In addition, the annotation ANN1 includes a number of data items that are linked to the corrected prediction.

FIG. 1 shows a dependency graph GRAPH_{D} for establishing the set of intermediate predictions P₁, P₂, P₃ and machine learning models ML₂, ML₁, ML₃ and learning functions to be corrected to take account of the change in the value of the final prediction Pf. Thanks to this dependency graph, the method of the invention makes it possible to collect the modified values of the intermediate predictions, here P₂′, and to reflect this new value in the training domain of the learning functions. One advantage of this is that learning functions which have only contributed to calculating an erroneous value of the intermediate prediction can be re-trained.

In the case of FIG. 1, it is understood that the intermediate prediction P₂ calculated by the second learning function FA₂ is used as input for the first learning function FA₁. As a result, the ML₂ training model is re-trained, as is the ML₁ training model. The GRAPH_{R} dependency graph is used to establish this re-training sequence.

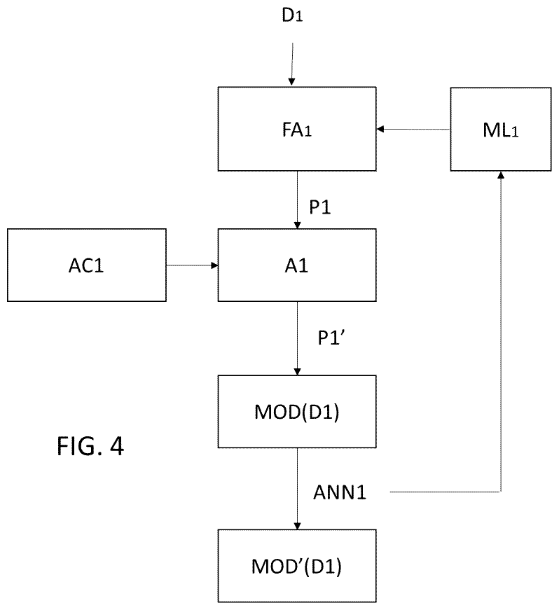

FIG. 4 shows a scenario in which a document model MOD(D₁) is used to process a document type recognized by a learning function FA₁. In this case, only one learning function FA₁ is used, but other cases could involve different learning functions to classify the document D₁ received as input. A prediction P₍₁₎, which in this case can be an intermediate prediction and a final prediction, is generated by the first learning function FA₁. This prediction Prin this case enables, for example, the document D₁ to be classified and an action A1 to be applied automatically to the document. A corrective action AC1 is initiated by a user. This corrective action AC1 generates a new value for prediction P1′.

The invention not only enables a new annotation to be generated automatically to re-train the model, but also to modify the document model MOD to be used for future actions. The new document model MOD′ can be generated by a calculation rule, a predefined algorithm or by a new learning function that can be trained by user data and/or data from the annotations produced by the corrective actions.

### Document Type

The document D₁ may be a technical document such as a technical specification, a user manual, an assembly manual, an accounting document such as a balance sheet, an estimate, an invoice, a letter, a plan, a certificate, an official document, a medical certificate, a form or any other document produced by an organization, an automated process or an individual. The documents dealt with under the invention are preferably documents relating to a type of document or a family of documents. The type of document can be defined by a generic name or a label enabling it to be associated with a type of document. It is understood that an invoice can be a type of document within an organization, as well as a technical specification for a product.

The document can be in a variety of formats, such as .txt, .pdf, .png, .jpg, .json, .xml, .doc, docx or any other document format that encodes a plurality of discrete symbols in a natural language.

According to some embodiments, the document can be an e-mail message. According to one embodiment, the digital document is an image file, a video file or an audio file. According to one embodiment, the document is a set of data received in real time, so it may be a video stream or an audio stream.

### Receipt of Document

The document D₁ may be received from a communication interface such as a network card, enabling data to be acquired from a remote entity such as a data server. In another case, the document D₁ may be stored in a memory in which a function can be used to retrieve the document stored there and perform an operation on it.

One objective of the invention is to extract data from said document to classify it with the best probability in order to perform actions on the document, in particular to automatically save it in a given memory.

### Learning Function

The method of the invention comprises the execution of at least one learning function generated by a machine learning model trained from a set of training data called the training domain.

Alternatively, the method of the invention comprises the execution of at least one learning function which is configured to query and/or retrieve data within a history. The function is called “learning” in this case because the history can include new data that is aggregated over time. The history can take the form of a database or a file. Updating the history with new data can be done automatically or by user action.

In the latter case, the learning function is not obtained from a machine learning model but may result from a predefined parameterization. The parameterization may, for example, correspond to the type of function, its coefficients and/or the directory(ies) used to extract and/or store information.

According to an embodiment of the invention, the method comprises the execution of a plurality of learning functions trained from different models. In particular, execution of the plurality of learning functions makes it possible to perform different functions on document D₁.

According to one embodiment, when a plurality of learning functions is executed, the method of the invention comprises the application of a prediction graph GRAPH_{P} and/or a dependency graph GRAPH_{D}.

The dependency graph GRAPH_{D} includes, in particular, for each action to be performed, a first sequence S₍₁₎ of execution of the various learning functions in order to perform said given action. The first sequence Simay result from a predefined configuration. It corresponds to the sequence of a series of algorithms. According to one example, each algorithm is executed on the basis of a learning function. The learning function is a machine learning model trained to calculate a prediction from input data. According to one embodiment, not all the algorithms in a sequence are solely learning functions; other algorithms such as algorithms comprising calculation rules may be sequenced among the functions implemented in a first sequence S₁.

The first sequence S₁ of the dependency graph GRAPH_{D} comprises a set of learning functions and/or algorithms that are configured to sequence in an automation. In addition, the first sequence S₁ includes the scheduling conditions and/or execution conditions for each function or algorithm. This means that the first sequence S₁ includes parameters for scheduling the functions/algorithms together, and parameters for validating, delaying or invalidating the execution of a function/algorithm.

The GRAPH_{D} dependency graph also includes a second sequence S₂ for each action corrected by a re-training user of the machine learning models that were executed during the first sequence S₁. The second sequence S₂ enables all models affected by a prediction error to be taken into account, where the model is directly or indirectly dependent on the erroneous prediction.

The second sequence S₂ of the dependency graph GRAPH_{D} comprises a set of re-trainings of each model of the learning functions or modifications of the algorithm settings. The second sequence S₂ enables these model re-trainings or algorithm modifications to be reconfigured within an automation system forming a feedback loop. In addition, the second sequence S₂ includes the scheduling conditions and/or execution conditions for each model retraining or algorithm modification. This means that the second sequence S₂ includes parameters for scheduling the retrainings or modifications among themselves, and parameters for validating, delaying or invalidating the execution of a retraining or algorithm modification.

A GRAPH_{P} prediction graph is used to calculate a final prediction from a plurality of intermediate predictions generated by a plurality of learning functions.

The learning functions can be generated by machine learning models with their own architectures. For example, a network architecture such as RNN (Recurrent Neural Network) or LSTM (Long short-term memory) can be used. According to another example, the machine learning model can be a Transformer, such as GPT-3, which stands for “generative Pre-Training Transformer” and is a model based on the Transformer architecture, i.e. certain layers of the model have the structure of a Transfromer.

An advantage of using a pre-trained network, for example of the Transformer type, is to utilize their good capabilities for processing data defining documents comprising discrete symbols encoded in a natural language. According to one embodiment, the invention is compatible with the use of already existing pre-trained networks, for example on platforms accessible from the Internet.

A pre-trained network of the BERT type, which in the literature stands for “Bidirectional Encoder representations from Transformers”, whose model also includes certain layers with the structure of a Transformer, can also be implemented within the scope of the present invention.

According to an example, when few classes are addressed by a classifier, for example between 5 and 10 classes, a machine learning model architecture can include the implementation of binary trees such as “Random Forest” or “XGBoost” or a convolutional neural network called CNN.

According to another example, when a large number of classes is addressed by a classifier, a machine learning model architecture can include the implementation of a Transformer model, for example of the BERT type, or a convolutional neural network called CNN.

Machine learning models can be configured within the framework of the invention to extract data from digital documents, such as dates, addresses, proper names, tables, signatures, structured information, sentiments and/or target sentences. A regex model architecture or a library such as “spacy” comprising different types of models, or a CNN or transition-based models can be used.

The models used to extract objects and named entities can implement a “transformer” type model or a BERT type model.

According to one embodiment, an architecture for recognizing patterns or motifs, such as a signature, in a digital document can implement a “YOLO” or “autoencoders” model.

### Classification Function

According to an embodiment, at least one learning function is executed in order to classify a received digital document D₁. The learning function FA₁ can implement, for example, an analysis aimed at extracting a document type, a date, a named entity such as an organization name or an individual name, an address or any other data enabling an action to be performed on the basis of knowledge of this data once extracted. In the latter case, some data extractions can be used to perform classification. However, according to another example, classification can be carried out without data extraction. For example, a classification of a received document does not necessarily involve extracting any data from said document. In one embodiment, one or more learning functions are executed to generate a prediction of the class of the extracted data. Each learning function can generate an intermediate prediction in order to calculate a final prediction.

According to one example, extracting a date from a received document D₁ can be used to classify this document in a “to be processed” directory, if it is an extraction of issue date(s) positioned at the document header, or in a “to be signed” directory, if a signature date is recorded at the end of the document, on the last page.

This example shows that the method of the invention can be applied using a single extraction to classify the document. However, according to different embodiments, the classification can result from a plurality of data extractions and an analysis of all the extracted data.

By way of example, FIG. 1 shows three learning functions FA₁, FA₂, FA₃ which extract data from a received document D₁.

According to this example, a first function FA₁ automatically extracts a characteristic date DATE₁, such as a due date, the second function FA₂ extracts a named entity NAME₁, such as an organization name, and the third function FA₃ extracts a document type TYPE₁, such as an invoice or an estimate.

Extracting the three characteristic data {DATE₁, NAME₁, TYPE₍₁₎} generates a prediction based on the set of three predictions generated by the three learning functions FA₁, FA₂, FA₃. This prediction is used to classify the document, which can lead to the execution of an automatic action. Each extraction is performed on the basis of each learning function, which has been defined on the basis of a machine learning model trained on a training domain.

The final prediction calculated from the three intermediate predictions of each of the learning functions is used to automatically perform an action on the document D₁.

The extracted data can be used to implement learning functions that exploit variables relating to font, style or font size. The position of certain elements can also be used, or contextual data to the data to be extracted.

In one embodiment, a prediction graph GRAPH_{P} can be used to calculate the final prediction Pf. According to the embodiment, this prediction graph enables:
weight intermediate predictions pi to calculate a final prediction and/or;
exclude actions or action scenarios according to the values or ranges of values of certain intermediate predictions and/or;
prioritize actions or sequences of actions.
Waiting for the reception of an intermediate prediction from a given learning function after the computation of a set of intermediate predictions from a plurality of learning functions before initiating an action. By “wait”, we mean to create an alert on the reception of data produced by a given function.

According to one example, the learning functions can be executed on different documents to generate an action on another document already created or to be created. The documents can be messaging messages or files.

According to one example, a part of a digital document D₁ is extracted, such as a table.

### Actions

Different actions can be generated according to the prediction made and according to a given configuration. In other words, a configuration makes it possible to define a link between the unit receiving a document D₁, the choice of learning functions to be executed and the action to be carried out under the conditions of a final prediction generated.

According to one embodiment, different actions can be generated by the method of the invention.

A first action A₁ involves automatically saving the document D₁ in a predefined directory. In one example, this action may be accompanied by a further action to delete the first document, which has been saved in a temporary directory prior to processing.

A second action A₂ comprises the automatic renaming of a document D₂. According to one example, this action may be performed consecutively or prior to an A₁ document D₂ registration action. In this case, document D₁ and D₂ may be the same document, when several actions are generated on the same document.

A third action A₃ involves extracting a portion of interest from document D₃ and integrating it into another given document, called edited document Dc. This document may be newly created. It is also understood that the third action A₃ may be combined with, consecutive to or prior to an action A₁ or A₂ or A₁ and A₂.

The edited document Dc can be saved in a predefined directory. According to one example, this third action A₃ may be accompanied by another action A₃′ aimed at extracting another portion from another document D₍₃₎′ of another type or of the same type to produce a single edited document Dc resulting from two portions extracted from two documents D₃, D_{3′}. For example, a “Purchase Order” document may be generated from content extracted from a quotation and an acceptance e-mail or quotation document signed by a party. This third action A₃ may be accompanied by a plurality of actions aimed at producing an edited document and/or actions aimed at validating the editing of such an edited document. According to one example, at least one extracted portion is used to edit a new document Dc. According to another example, several extracted portions of the same document D₃ are used to produce an edited document Dc.

According to an embodiment in which a table is extracted with values from a first document D₃, an action may be to regenerate another document comprising values from said table combined, for example, with other values from another table in another document.

According to another example, a fourth action may correspond to the creation of a category of a parameter or extracted value. This may involve, for example, a new named entity, i.e. a new organization that is not yet referenced in a database. In this case, the final prediction calculated from a plurality of learning functions having, for example, determined a document type, a date, an amount and a new organization name, is the creation of a new directory. The new directory may correspond to the directory in which all the invoices of this new named entity will be stored.

According to another example, a fifth action corresponds to the segmentation of a D₁ document into at least two documents. The segmentation can correspond to a set of document pages. A segmented document can then be classified by another learning function and processed by another learning function to extract further data in order to generate another action. This example illustrates that an action can comprise several sub-actions.

### Classification Representation

In one embodiment, a representation of the decision, i.e. the classification of the D₁ document or action, is generated. The representation is preferably generated from a user interface based on a display.

The representation can be, for example, an iconography of a file stored in a directory, i.e. an icon representing document D₁. This representation is particularly suitable when the action aims to automatically move a document following calculation of the final prediction.

According to one example, the representation can be generated from an interface representing the classification of document D₁. In this case, a keyword or class name can be associated with document D₁. This representation is useful when you want to check the classification of a document and the score associated with its prediction. It is also useful for identifying the variables used to calculate the final prediction.

In another example, an action is represented by the display of the name of document D₁, which has been automatically renamed. In the latter case, the action may correspond to the renaming of document D₁.

According to another example, the representation of an action is the opening of an edited or created document to display at least one area of interest in the digital document.

In one embodiment, the final prediction or the classification based on the final prediction generates a notification that is automatically sent to a user whose e-mail address is predetermined or whose e-mail address is deduced from a metadata of an action performed by said user. The notification includes a link to a remote entity's resource and displays either the prediction, action or classification via a user interface. The user is then invited to validate or correct the prediction, classification or action.

### Automatic Prediction Verification

According to an embodiment, the method of the invention comprises a step of verifying the final prediction with a prediction consistency test. The consistency test can be carried out on the basis of a document model, also known as a “template”, or a scenario model designed to check the consistency of a final prediction, for example on the basis of rules.

A document model is used to validate that the final prediction results in the generation, modification or creation of a document that has a given predefined model. This verification can be used, for example, to test the consistency of data expected in a given area of a document with the area actually controlled by a document model.

The document model can be associated with a score that is automatically calculated as a function of the annotations that have been issued previously and therefore of the domain training of each learning function acting on a digital document D₁ comprising a document model. One advantage is to quickly identify whether a document model is reliable or whether it is necessary to train the machine learning model to improve the fidelity of the document model.

A scenario model is used to validate that the final prediction results in an action that fits into a list of expected tasks, or results in a classification without affecting other parameter values, or at least that these values remain within a given range.

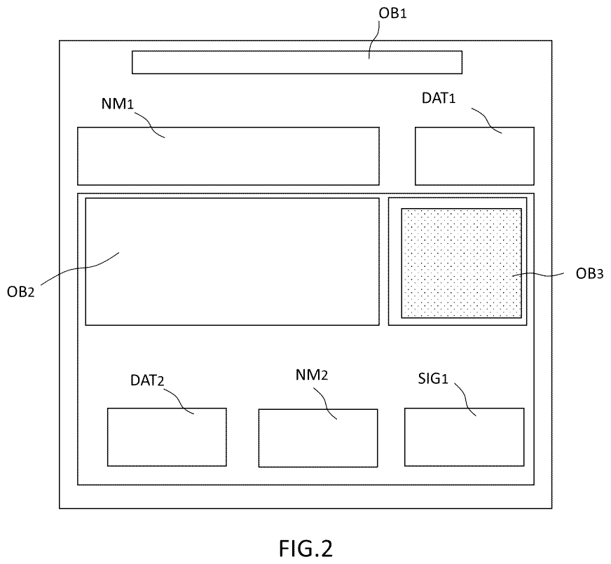

FIG. 2 shows an example of a document model that can be used to check the consistency of a prediction and possibly calculate a score for the calculated prediction.

FIG. 2 shows a model in which a number of objects OB₁, OB₂, OB₃ representing headers, illustrations or paragraphs can be labeled to indicate characteristic data fields. In the model shown in FIG. 2, a first date field DAT₁ and a second date field DAT₂ represent, for example, a mail date and a signature date respectively.

In this example, the NM₁ field is that of a named entity, such as the name and address of an organization receiving the document. Another NM₂ field is used to label another named entity, such as another organization name, for example an organization that publishes the document. In this example, a signature zone is indicated as SIG₁ in FIG. 2 and represents a zone to which a signature is expected.

According to one example, a document model such as the one shown in FIG. 2 can be used initially to generate an initial training of a machine learning model for executing one or more learning functions. According to another example, the model is built from real documents and is used to perform a consistency check with predictions calculated by learning functions.

In another example, a document template can be used to generate another document template.

### Corrective Action

The method of the invention enables a user to perform a corrective action on document D₁ from a user interface.

In one embodiment, the corrective action AC₁ corresponds to a displacement of the document D₁ which has previously been automatically saved by the execution of at least one learning function. A move resulting from a corrective action AC₁ enables the memory resource storing the document to be modified, or the link enabling it to be accessed to be modified.

In another embodiment, the corrective action AC₂ corresponds to a renaming of a document D₁ or D₂ which has previously been automatically renamed by the execution of at least one learning function. A renaming of a D₁ or D₂ document resulting from an AC₁ corrective action modifies the name of the D₁ or D₂ digital document. Here, the name “D₁” is used when the document has previously been automatically moved to a directory before being renamed. D₂” is used when the document has been automatically renamed without having been previously moved to a directory.

In another embodiment, the corrective action AC₃ corresponds to a correction made to a document produced by the first action, such as action A₍₃₎, following the execution of at least one learning function.

The acquisition of the corrective action can be carried out according to different embodiments of the invention.

In a first embodiment, the corrective action is acquired by means of a user interface specially designed to inform a corrective action. This user interface comprises a field for designating the document to which a corrective action is to be applied, and a field for performing the corrective action. This corrective action is then carried out in two stages: the first stage defines the action to be taken, and the second stage executes the corrective action on the basis of the data acquired by the interface. One advantage is that the corrected data can be better acquired and enriched by the user interface.

In a second embodiment, the corrective action is acquired directly from a file explorer, enabling a file to be moved from one directory to another, or the file name to be accessed for editing, for example by selecting an icon representing the digital document. One advantage of this option is that it can be carried out in just a few seconds, directly by user action.

According to a third embodiment, the corrective action is acquired directly within the document D₁, D₂, or D₃ from a user interface enabling the contents of the document to be viewed, in order to edit at least one item of data in this document. Editing consists in correcting a piece of document data, which may be numeric or alphabetic, such as a date or a named entity. According to an example, it may be a portion of a page such as a paragraph, an image or a portion of the page. In another example, it may be an area of a page or a plurality of pages.

According to a fourth embodiment, which is an improved embodiment of the third embodiment, a document template is used to interpret a user's corrective action within a document that has been generated by the first action. The advantage of using a document model is that it automatically recognizes modified information in a file in order to extract additional data associated with this modification or to enrich the modified information with additional data from another source. One advantage is to identify the erroneous prediction made by the learning function and to determine the set of parameter values that contributed to producing this erroneous prediction.

According to one example, if a list of values in a document is corrected by a corrective action either by deleting a value, adding a value or modifying a value in the list, then the model recovers the set of values in the list that has not been corrected and recovers the set of data used to produce the erroneous prediction and the correct predictions. One benefit is to improve the training of machine learning models.

### Generation of a Modified Prediction value

In one example, the corrective action automatically generates a corrected prediction value and an annotation.

The method of the invention enables the modified value representative of the corrective action AC₁, AC₂, i.e. the value of the final prediction, to be stored. The value can be a directory name or a file name with a given nomenclature.

The modified value of the corrective action AC₁, AC₂ can be stored together with the resulting value of the first action A₁, respectively A₂. If the document has been saved in a folder “A” and a corrective action has led to this document being moved to a new folder “B”, the method of the invention enables this new value “B” to be saved and associated with the old value “A”.

### Annotation Generation

At the end of the corrective action, an annotation is automatically generated as a result of the corrective action. The annotation may include the new value resulting from the corrective action, i.e. the corrected value of the prediction, and possibly the old value of the first action performed on the first digital document, i.e. the final prediction.

In addition, the generated annotation advantageously comprises a set of values of interest extracted or generated in particular from the first digital document D₁ or any other analyzed document. These values of interest are associated with system variables such as an organization name, a due date or delivery date, an address, etc. These variables of interest are themselves associated with system variables. These variables of interest are themselves associated with metadata that can be exploited in an annotation to improve domain training.

In particular, the annotation can include the set of predictions for each learning function and the set of data for the first document D₁ used to calculate each prediction. This data may include text fields, date fields or numbers. This data may include indicators of the presence of iconography, signatures, headers or initials, etc. These data may include characteristic values for a geometric area of a document page, characteristic position(s), or a document page number, etc.

Many of the data, known as values of interest or variables of interest, that have been used to calculate predictions can be collected when a corrective action has been performed, in order to enhance a training domain. According to one example, values of interest preceding a corrected prediction and values of interest following in a reading order of the document can be extracted for insertion into the annotation. One advantage is to obtain context data directly associated in the document with the corrected prediction. This data can be used, for example, to improve relearning by consolidating contextual checks on the corrected prediction.

In one embodiment, the annotation is stored in a memory.

According to one example, the annotation is generated according to a predefined sequence that requires data to be stored temporarily while waiting for other data to be calculated later in order to generate the annotation in full.

According to an embodiment, the annotation produced comprises a document identifier and/or a user identifier, for example an email and/or a date on which the first action A₁ was carried out and/or the date on which the corrective action AC₁ was carried out. These data also constitute variables of interest.

In one embodiment, the generated annotation is displayed in a user interface. According to an example, this annotation can be modified by a user.

In one embodiment, the generation of a modified value of a prediction or a new annotation enables a notification to be automatically sent to a given recipient user. The recipient user ID or address can be pre-configured according to the type of document or directory associated with the prediction. In another example, the recipient user is identified by a metadata associated with the digital document being processed.

According to one example, retraining of at least one model can be initiated after a given number of annotations have been generated.

### Training and Practice Areas

In a first embodiment, the annotation feeds a training domain of at least one learning function. According to one example, a plurality of training domains of a plurality of learning functions are modified as a result of the corrective action.

In a second embodiment, at least one predefined rule is modified following the generation of a corrective action.

In a third embodiment, an operation validation is required from a given user following the generation of a corrective action. Validation of the operation can result in the retraining of a learning function from the modified training domain and/or the modification of a rule from the annotation.

According to one example, a rule modification may involve adding a value to a set of possible values of a variable, such as a document type, a named entity category or a date nomenclature.

The method of the invention allows the second sequence S₂ of the GRAPH_{D} dependency graph to be taken into account in order to modify models and algorithms. In particular, the second sequence S₂ of the GRAPH_{D} dependency graph makes it possible to link predictions produced by one algorithm to other predictions produced by other algorithms, where this is the case.

In one embodiment, the second sequence S₂ takes into account the occurrences of similar annotations, or their frequency over time, or their singularity, to apply re-trainings or algorithm modifications in a second sequence S₂ aimed at re-training or modifying a plurality of functions or algorithms. By way of example, an annotation that has many occurrences may, in one embodiment, be used less frequently to update a machine learning model of a given learning function. Conversely, an annotation with few occurrences may be taken into account more quickly by the retraining process.

According to an embodiment, the corrective action AC₁ or AC₂ or the prediction modification leads to the modification of a parameterization of the second sequence S₂ in order to generate a retraining sequence adapted to the corrective action or the modified prediction. One advantage is to retrain models that have only contributed to generating an erroneous prediction, without affecting the retraining of machine learning models of functions that have produced non-erroneous intermediate predictions.

The dependency graph GRAPH_{D} therefore makes it possible to optimize useful retraining operations without affecting the entire processing chain—organized by the first S₁ or second S₂ sequence. Furthermore, the dissociation in the dependency graph GRAPH_{D} of the first sequence and the second sequence enables functions to be executed while organizing their retraining according to the process implementation.

### History Management

According to an embodiment, the method includes a step of validation by a user from a user interface of a retraining of a set of documents already classified in a directory. One advantage of this feature is that, in the event of a corrective action resulting in a change in prediction likely to affect a modification in the behavior of a learning function, this behavior can be reflected in a history in order to update a document classification set.

This mode of implementation works with different actions, such as automatically moving a received document or renaming a document, or segmenting or creating a document.

Alternatively, the validation step can be used to avoid the impact of a change in function behavior on a document history that has already been processed. In this way, the user can dissociate the processing of the history according to the actions carried out, which differs according to the use case.

### System Integration

According to one embodiment, the method of the invention comprises the integration of a data resource, which may be a database of named entities such as an address book, a document database such as an e-mail system, or any other database containing data that can be queried by a request generated by the method.

An interesting feature is the integration of a layer enabling an existing system to communicate with the machine learning models of the method of the invention. This layer makes it possible to normalize an existing system's data set with data that can be vectorized and taken into account as input for the learning functions or algorithms implemented by the method of the invention.

According to one embodiment, the method of the invention is implemented in a collaborative workspace accessible from at least one data server. In this case, when a file is moved from one directory to another in a collaborative workspace, an event is automatically generated. This operation can be relative to each or certain user action(s). This event is generally generated in order to synchronize different resources for a set of individuals with access to the workspace. Such an event may be an electronic notification issued by a communication interface. In one embodiment, this event is used to activate the detection of an action to move a document from one directory to another as part of a corrective action carried out by a user.

According to another embodiment, the method of the invention is implemented in a workspace in which an algorithm is configured to browse changes made within a directory such as adding a document, deleting a document, renaming a document, etc.

This algorithm automatically detects a change and generates a modification to the prediction, thus generating a new annotation.

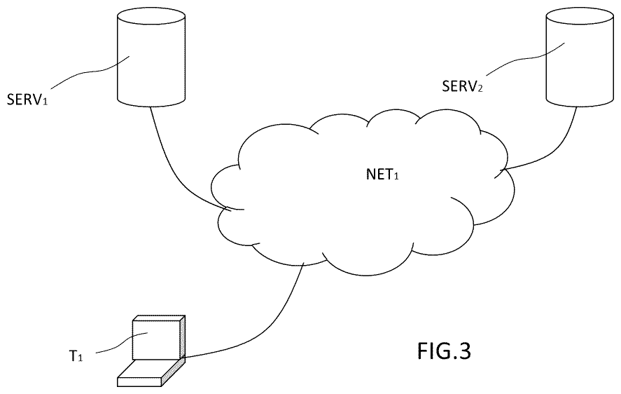

FIG. 3 shows an example of the elements of a system for implementing the method of the invention. FIG. 3 shows a data network NET₁, which may be the Internet. A first user terminal T₁ provides access to a remote server SERV₁, which hosts a collaborative workspace. This space includes memory resources for storing digital documents received and automatically processing them. A second server SERV₂ includes the means for generating models and executing certain functions and algorithms of the method of the invention.

Depending on the type of implementation, the models and configurations of the learning functions can be stored directly on the server hosting the collaborative workspace on which the method of the invention runs. However, in a preferred mode, a server dedicated to their storage and execution is used.

In one embodiment, one or more configuration files may include additional data for training or applying a model, which may include parameters, intermediate results or annotations generated as a result of corrective action. The configuration or the document using the configuration can be downloaded at any time and put on hold until all the data and documents required to apply or retrain the models are associated. In one case, configurations are associated with documents if one or more conditions are validated. A condition may be the execution of a function or a command.

One advantage is that documents and configuration data can be collected from several systems that do not communicate with each other, and templates can only be applied to documents when sufficient documents and data are available.

One advantage is that new documents to be processed can be taken into account independently of any re-training that may be reapplied. The configuration for re-training one or more learning functions can be activated or programmed following the processing of a plurality of documents. In this way, re-training can take into account a plurality of input documents.

In one case, a corrective action on a single document can be taken into account to generate a new prediction for a plurality of documents.

1. A computer-implemented method for improving a classification of at least one document on the basis of at least one machine learning model, the computer-implemented method comprising:
receiving a first digital document;
executing a first learning function generated by a first machine learning model trained from a first training domain to generate a prediction of a classification of the first digital document within a first class to perform a first automatic action on the digital document, said first action comprising at least one move of said first digital document to a first directory.
generating a representation of this classification and of the action performed on the first digital document by means of a user interface;
acquiring a first corrective action from a user relating to the modification of the movement of the first digital document to a second directory;
generating a first annotation comprising on the one hand the modified value of the prediction corrected on the basis of the first corrective action and on the other hand a set of values of interest extracted or generated in particular from the first digital document;
modifying the first training domain by adding the first annotation (ANN₁) after collecting at least one annotation;
re-training the first machine learning model from the modified training domain.

2. The computer-implemented method according to claim 1, wherein the first corrective action relating to the modification of the displacement of the first digital document is carried out by moving the first digital document from the first directory to a second directory by a user action from a document explorer, an algorithm for detecting a change in the memory resource allocated to a digital document being implemented.

3. The computer-implemented method according to claim 1, wherein the first corrective action relating to the modification of the displacement of the first digital document is carried out by a modification of the class of the first digital document by a user action from a user interface presenting a set of characteristic data of the first digital document.

4. The computer-implemented method according to claim 1, comprising:
receiving a second digital document;
executing a second learning function generated by a second machine learning model trained from a second training domain for generating a prediction of a classification of the second digital document within a second class and performing a second automatic action on the second digital document, said second action comprising at least one automatic renaming of said second digital document,
generating a representation of this classification and of the action performed on the first digital document from a user interface;
acquiring a second corrective action from a user relating to the modification of the name of the second digital document;
generating a second annotation comprising, on the one hand, the modified value of the prediction relating to the second corrective action and, on the other hand, a set of values of a second data sequence extracted or generated in particular from the second digital document;
modifying the second training domain by adding the second annotation;
generating a retraining of the second machine learning model.

5. The computer-implemented method according to claim 4, wherein the second corrective action relating to the modification of the name of the second digital document is carried out by modifying the name of the second digital document directly on the file corresponding to the second digital document.

6. The computer-implemented method according to claim 4, wherein the second corrective action relating to the modification of the name of the second digital document is carried out by a modification of the class of the second digital document by a user action from a user interface presenting a set of characteristic data of the second digital document.

7. The computer-implemented method according to claim 1, comprising:
receiving a digital document;
executing of a third learning function generated from a third machine learning model trained from a third training domain to generate a prediction relating to the detection of a class of a characteristic date present in the digital document and extract said characteristic date from the first document;
generating a classification representation of at least the characteristic date extracted from a user interface;
acquiring a third corrective action from a user relating to the modification of the class of the characteristic date of the first digital document;
generating a third annotation comprising, on the one hand, the modified value of the prediction relative to the first corrective modification and, on the other hand, a set of values of interest extracted or generated in particular from the digital document;
modifying the third training domain by adding the third annotation;
generating of a re-training of the third machine learning model.

8. The computer-implemented method according to claim 7, wherein the third learning function is executed prior to the first learning function, the corrected prediction being a datum of the set of values of interest of an annotation, said corrected prediction modification resulting in the modification of the first training domain and/or the modification of the second training domain.

9. The computer-implemented method according to claim 1, comprising receiving a dependency graph, said dependencies being defined between at least the first learning function and a second learning function, said dependency graph including a description of the inputs of at least one training domain, said inputs including at least one value corresponding to an output of at least one learning function.

10. The computer-implemented method according to claim 9, comprising:
acquiring of a dependency graph between a plurality of learning functions chosen from a set of learning functions comprising the first learning function, the second learning function and the third learning function;
adding at least one set of values of interest produced when creating an annotation of a modified prediction of a given learning function so as to:
modifying of a training domain of a learning function other than the given learning function;
machine learning model retraining.

11. The computer-implemented method according to claim 1, wherein following an automatic action performed by a learning function, a first notification is sent via a data network, said first notification including access to a user interface enabling the annotations associated with this action to be modified.

12. The computer-implemented method according to claim 1, wherein the first machine learning model is generated from the definition of a first digital document model comprising the identification of a plurality of characteristic data and areas of interest of said first document model and from a user interface.

13. The computer-implemented method according to claim 12, wherein following a corrective action generated by a user, the model of the first digital document is used to extract context data from the modified prediction to enrich the annotation that is created.

14. The computer-implemented method according to claim 12, wherein the definition of a first digital document model comprises the generation of a form comprising a set of choices defining annotations of said model, said annotations enabling the first training model to be updated.

15. The computer-implemented method according to claim 1, wherein a plurality of first documents are received from a same class, and a plurality of machine learning models are applied, the method comprising the generation of a plurality of predictions, the method including the selection of a prediction, said selection of said prediction allowing to update the first training domain.

16. A system comprising a user's electronic terminal comprising at least one computer, a memory, a display and a communication interface for transmitting messages over a data network to at least one first server comprising hardware resources for executing the first learning function, the second learning function, the third learning function and a memory for storing the learned patterns in order to perform the steps of the method in claim 1, the third learning function and a memory for storing the learned models in order to execute the steps of the method, the terminal comprising a user interface for acquiring an annotation comprising a modification of a prediction, said modification resulting in the retraining of at least one machine learning model.
